(19) United States
(12) Patent Application Publication
(10) Pub. No.: US 2012/0211096 A1
(43) Pub. Date: Aug. 23, 2012

(54) CHECK VALVE AND VACUUM SYSTEM

(75) Inventors: Huan-Che Huang, Hsinchu County (TW); Kuan-Ting Chen, New Taipei City (TW); Chih-Chang Chen, Changhua County (TW)

(73) Assignee: MAXCHIP ELECTRONICS CORP., Hsinchu City (TW)

(21) Appl. No.: 13/114,018

(22) Filed: May 23, 2011

(30) Foreign Application Priority Data
Feb. 21, 2011 (TW) 100105645

(51) Int. Cl. F16K 15/02

(52) U.S. Cl. 137/528

(57) ABSTRACT

A check valve includes a case body, a piston device, and a blocking plate. The case body includes a first case part and a second case part. The first case part has a first opening. The second case part has a second opening and a third opening. The second opening faces the first opening, and the third opening is located at one side of the second opening. The first case part and the second case part are combined to form the case body, and the case body has a fluid passage therein. The piston device is aligned to the second opening and mounted on the second case part. The blocking plate is disposed on the piston device. When the piston device operates, the piston device pushes the blocking plate to seal the first opening.

### CROSS-REFERENCE TO RELATED APPLICATION

This application claims the priority benefit of Taiwan application serial no. 100105645, filed Feb. 21, 2011. The entirety of the above-mentioned patent application is hereby incorporated by reference herein and made a part of this specification.

### BACKGROUND OF THE INVENTION

1. Field of the Invention

The invention relates to a check valve system. More particularly, the invention relates to a check valve and a vacuum system that can effectively prevent the back-stream phenomenon.

2. Description of Related Art

The vacuum systems are extensively applied to semiconductor manufacturing equipment. Specifically, the vacuum systems are required to operate the expensive apparatuses under an adequate pressure. Here, the apparatuses include the leading manufacturing apparatuses, such as thin film deposition apparatuses, dry etching apparatuses, ion implantation apparatuses, lithography apparatuses, and the semiconductor surface analyzers that include scanning electron microscopes and secondary ion mass spectroscopes.

However, when vacuum pumps in the vacuum systems malfunction, gas back-stream occurs in the pipes of the vacuum systems, and particles and powder in the pipes are brought back to the manufacturing equipment, which leads to contamination of the manufacturing equipment and damages to products.

### SUMMARY OF THE INVENTION

The invention is directed to a check valve that can effectively prevent fluid back-stream.

The invention is further directed to a vacuum system that can prevent contamination of manufacturing equipment.

In an embodiment of the invention, a check valve that includes a case body, a piston device, and a blocking plate is provided. The case body includes a first case part and a second case part. The first case part has a first opening. The second case part has a second opening and a third opening. The second opening faces the first opening, and the third opening is located at one side of the second opening. The first case part and the second case part are combined to form the case body that has a fluid passage therein. The piston device is aligned to the second opening and mounted on the second case part. The blocking plate is disposed on the piston device. When the piston device operates, the piston device pushes the blocking plate to seal the first opening.

According to an embodiment of the invention, in the check valve, the blocking plate has a ring-shaped protrusion, and the first case part has a ring-shaped slot for accommodating the ring-shaped protrusion, for instance. Here, the ring-shaped slot surrounds the first opening, for instance.

According to an embodiment of the invention, the check valve further includes an O-shaped ring that is disposed in the ring-shaped slot.

According to an embodiment of the invention, in the check valve, a shape of a cross-section of the ring-shaped protrusion is a cone shape or a rectangular shape, for instance.

According to an embodiment of the invention, in the check valve, the blocking plate has a retaining lever, for instance. The retaining lever extends toward a direction of the first opening. The first case part has a retaining element, for instance. The retaining element extends into the first opening and has a hole, and the retaining lever passes through the hole.

According to an embodiment of the invention, the check valve further includes a first combination device for combining the first case part and the second case part.

According to an embodiment of the invention, the check valve further includes a second combination device for mounting the piston device on the second case part.

According to an embodiment of the invention, in the check valve, the piston device includes a piston and a cylinder. The cylinder accommodates the piston.

According to an embodiment of the invention, in the check valve, the cylinder has a vent hole thereon, for instance.

In an embodiment of the invention, a vacuum system for performing a vacuum pumping process on manufacturing equipment is provided. The vacuum system includes a pump and the aforesaid check valve. The check valve communicates the pump and the manufacturing equipment.

According to an embodiment of the invention, the vacuum system further includes an electromagnetic valve that has a gas inlet and a gas outlet. The gas outlet communicates a vent hole of the piston device.

According to an embodiment of the invention, the vacuum system further includes a gas transmission pipe that communicates the gas inlet to a gas source.

According to an embodiment of the invention, the vacuum system further includes a power supply that is coupled to the electromagnetic valve.

Based on the above, in the check valve described in the embodiments of the invention, the blocking plate seals the first opening when the piston device operates, which can effectively prevent fluid back-stream. Besides, fluids can be rapidly isolated by the check valve described in the embodiments of the invention. The manufacturing costs of the check valve are low, and the check valve can be easily installed. Additionally, the check valve described in the embodiments of the invention is applicable to various pipes and manufacturing equipment.

On the other hand, the vacuum system described in the embodiments of the invention is equipped with the aforesaid check valve, and thus pollutants including particles and powder can be prevented from back-streaming to the manufacturing equipment together with fluids. Thereby, the products are not damaged or contaminated by the pollutants.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an assembly of a check valve according to an embodiment of the invention.

FIG. 2 is an exploded view illustrating a check valve according to an embodiment of the invention.

FIG. 3 is a side perspective view illustrating that the piston device in FIG. 1 does not operate.

FIG. 4 is a side perspective view illustrating that the piston device in FIG. 1 operates.

FIG. 5 is a schematic view illustrating a vacuum system according to an embodiment of the invention.

### DESCRIPTION OF EMBODIMENTS

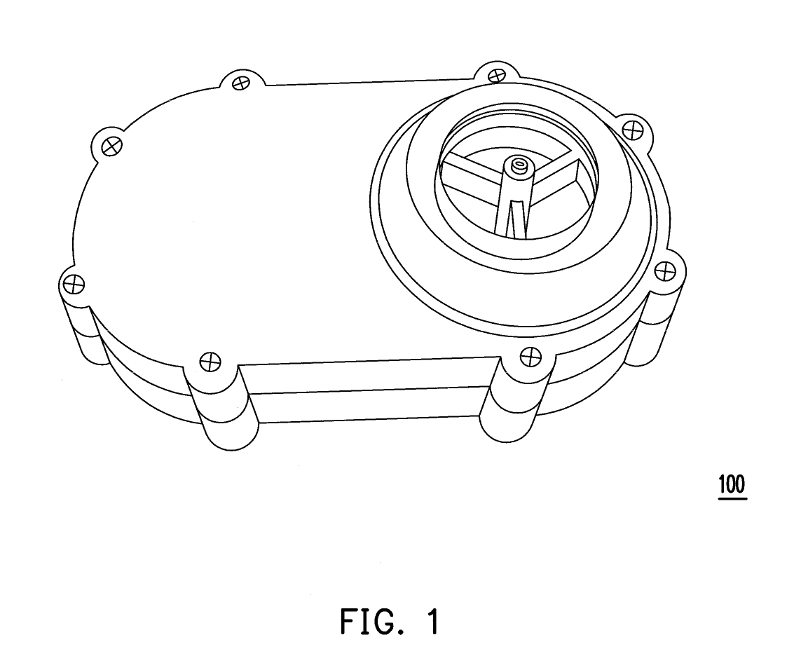

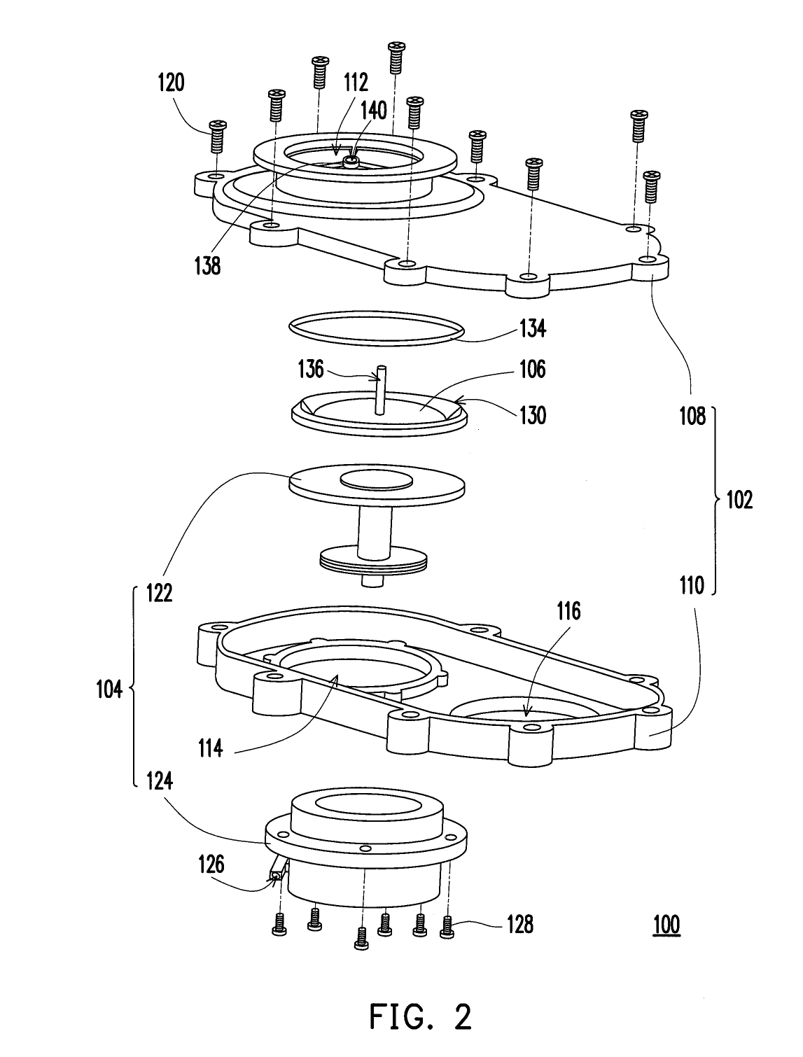

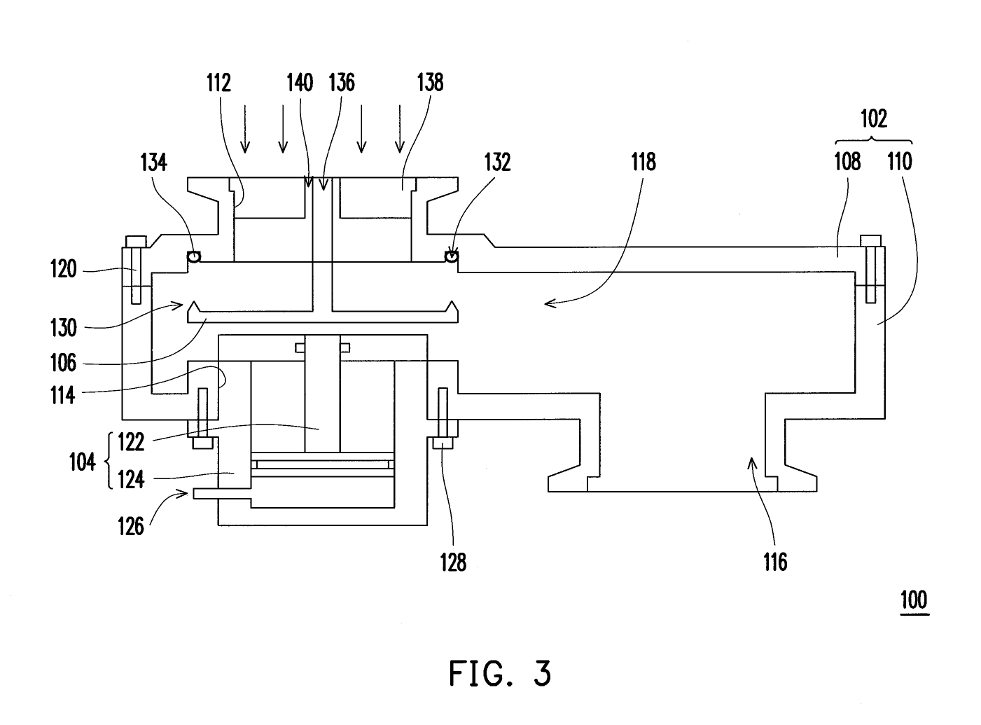

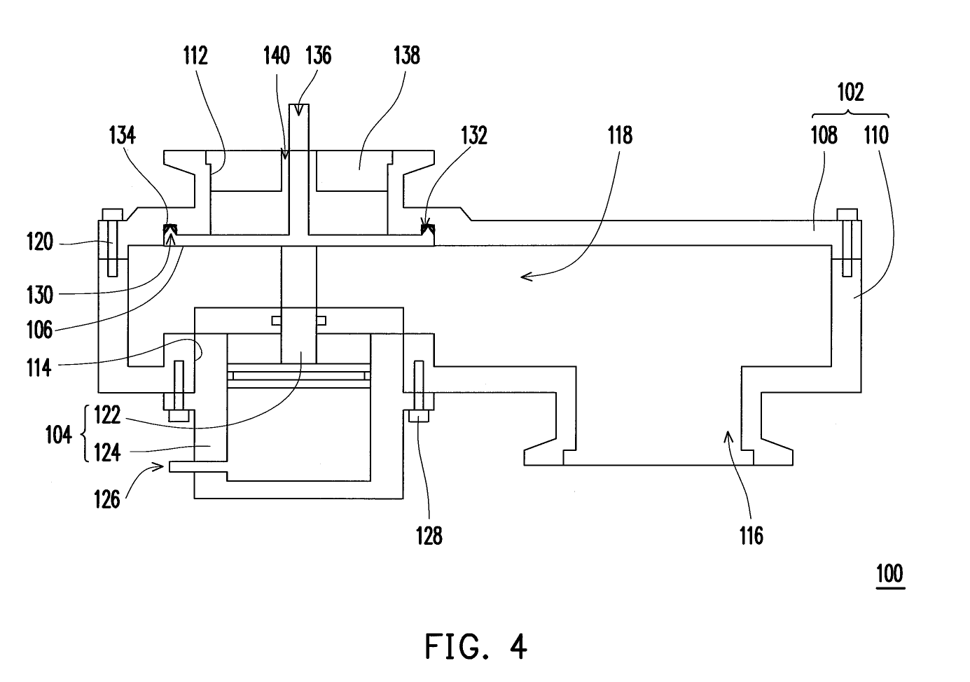

FIG. 1 illustrates an assembly of a check valve according to an embodiment of the invention. FIG. 2 is an exploded view illustrating a check valve according to an embodiment of the invention. FIG. 3 is a side perspective view illustrating the piston device in FIG. 1 does not operate. FIG. 4 is a side perspective view illustrating that the piston device in FIG. 1 operates.

With reference to FIG. 1 to FIG. 4, the check valve 100 includes a case body 102, a piston device 104, and a blocking plate 106. The check valve 100 is applicable to various pipes and manufacturing equipment.

The case body 102 includes a first case part 108 and a second case part 110. The first case part 108 has a first opening 112. The second case part 110 has a second opening 114 and a third opening 116. The second opening 114 faces the first opening 112, and the third opening 116 is located at one side of the second opening 114. The first case part 108 and the second case part 110 are combined to foim the case body 102 that has a fluid passage 118 therein. The fluid passage 118 communicates the first opening 112 and the third opening 116, for instance. The first case part 108 and the second case part 110 are respectively made of metal materials, e.g., aluminum alloy, which should not be construed as a limitation to the invention.

In addition, the check valve 100 can selectively include a first combination device 120 for combining the first case part 108 and the second case part 110, while the way to combine the first and second case parts 108 and 110 is not limited in the invention. The first combination device 120 in this embodiment is a screw set, for instance.

The piston device 104 is aligned to the second opening 114 and mounted on the second case part 110. Besides, the piston device 104 includes a piston 122 and a cylinder 124. The cylinder 124 accommodates the piston 122. Here, the cylinder 124, for instance, has a vent hole 126 for introducing gas into the cylinder 124. The piston 122 and the cylinder 124 are respectively made of metal materials, e.g., aluminum alloy, for instance.

The check valve 100 can selectively include a second combination device 128 for mounting the piston device 104 on the second case part 110. However, the way to mount the piston device 104 is not limited in the invention. The second combination device 128 in this embodiment is a screw set, for instance.

The blocking plate 106 is disposed on the piston device 104. When the piston device 104 operates, the piston device 104 pushes the blocking plate 106 to seal the first opening 112 and thereby prevent fluid back-stream. The blocking plate 106 is made of metal materials, e.g., aluminum alloy, for instance.

Additionally, the blocking plate 106 has a ring-shaped protrusion 130, for instance, and the first case part 108 has a ring-shaped slot 132 for accommodating the ring-shaped protrusion 130. Here, the ring-shaped slot 132 surrounds the first opening 112, for instance. When the piston device 104 operates, the ring-shaped protrusion 130 of the blocking plate 106 is engaged with the ring-shaped slot 132 of the first case part 108, such that the blocking plate 106 can better seal the first opening 112.

Further, the check valve 100 can selectively include an O-shaped ring 134 that is disposed in the ring-shaped slot 132. The O-shaped ring 134 is a normal O-shaped ring, for instance. Alternatively, the O-shaped ring 134 may be made of a fluorine-containing material, for instance. When the ring-shaped protrusion 130 of the blocking plate 106 presses on the O-shaped ring 134, the ring-shaped protrusion 130 can be tightly engaged with the O-shaped ring 134, and thereby the blocking plate 106 can better seal the first opening 112. A shape of a cross-section of the ring-shaped protrusion 130 is a cone shape or a rectangular shape, for instance, which should not be construed as a limitation to the invention. In this embodiment, the cross-section of the ring-shaped protrusion 130 is in a cone shape, for instance. The pressure exerted by the ring-shaped protrusion 130 that has a corn-shaped cross-section can be centered on the O-shaped ring 134, such that the ring-shaped protrusion 130 can be engaged with the O-shaped ring 134 even more tightly.

Besides, in this embodiment, the blocking plate 106 has a retaining lever 136 thereon, for instance. The first case part 108 has a retaining element 138, for instance. However, the invention is not limited thereto. The retaining lever 136 extends toward a direction of the first opening 112, for instance. The retaining element 138 extends into the first opening 112 and has a hole 140, for instance. Here, the retaining lever 136 passes through the hole 140. Since the retaining lever 136 of this embodiment passes through the hole 140, the moving path of the blocking plate 106 is not deviated when the piston device 104 operates and pushes the blocking plate 106.

With reference to FIG. 3 and FIG. 4, when the piston device 104 does not operate, the blocking plate 106 is located at a relatively low position, and the fluid passage 118 in the case body 102 is in an open state, as shown in FIG. 3. When the piston device 104 operates, the piston 122 of the piston device 104 pushes the blocking plate 106 to a relatively high position. Thereby, the blocking plate 106 and the first case part 108 are tightly bonded to seal the first opening 112. Hence, the fluid passage 118 in the case body 102 is in a close state, as shown in FIG. 4.

Note that an O-shaped ring (not shown) can be further disposed respectively at the connection portion of the first and second case parts 108 and 110 and the connection portion of the piston device 104 and the second case part 110 in order to improve the bonding strength. This is known to people having ordinary skill in the pertinent art and is thus not reiterated herein.

Based on the above embodiments, when the piston device 104 operates, the blocking plate 106 of the check valve 100 seals the first opening 112, so as to effectively prevent fluid (gas or liquid) back-stream. Besides, fluids can be rapidly isolated by the check valve 100 described in the embodiments of the invention. The manufacturing costs of the check valve are low, and the check valve can be easily installed.

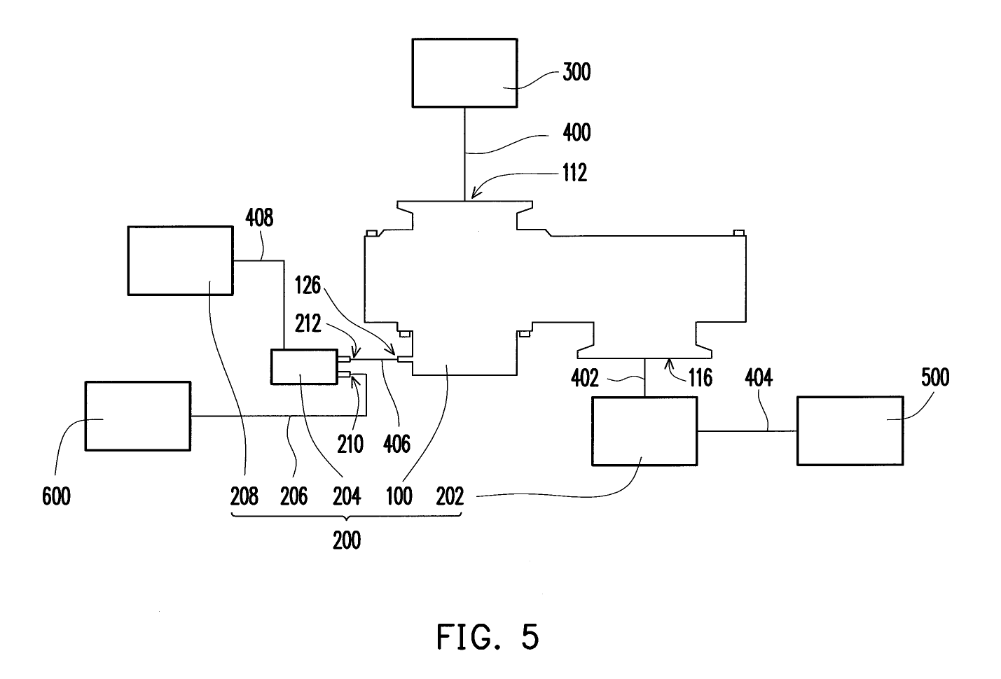

FIG. 5 is a schematic view illustrating a vacuum system according to an embodiment of the invention.

As indicated in FIG. 3 to FIG. 5, the vacuum system 200 can be applied to perform a vacuum pumping process on manufacturing equipment 300. The vacuum system 200 includes a pump 202 and the check valve 100. The check valve 100 communicates the pump 202 and the manufacturing equipment 300. The configurations, the materials, and the effects of components in the check valve 100 are elaborated in the previous embodiments, and therefore no further description is given herein. The pump 202 is a vacuum pump, for instance. The manufacturing equipment 300 is a semiconductor manufacturing machine, for instance.

In this embodiment, the check valve 100, the pump 202, and the manufacturing equipment 300 are communicated by communicating the manufacturing equipment 300 to the first opening 112 of the check valve 100 through a pipe 400 and communicating the pump 202 to the third opening 116 of the check valve 100 through the pipe 402. Note that the way to communicate the check valve 100, the pump 202, and the manufacturing equipment 300 is not limited in the invention.

For instance, the pump 202 is communicated to a scrubber 500 through the pipe 404, which should not be construed as a limitation to the invention.

Besides, the vacuum system 200 can selectively include an electromagnetic valve 204, a gas transmission pipe 206, a power supply 208, or a combination thereof.

The electromagnetic valve 204 has a gas inlet 210 and a gas outlet 212, and the gas outlet 212 communicates the vent hole 126 of the piston device 104. The electromagnetic valve 204 can determine whether the gas enters the cylinder 124 of the piston device 104 or not. Here, the electromagnetic valve 204 communicates the gas outlet 212 to the vent hole 126 of the piston device 104 through the pipe 406, for instance.

The gas transmission pipe 206 communicates the gas inlet 210 to a gas source 600, so as to supply the cylinder 124 of the piston device 104 with the gas coming from the gas source 600. Here, the gas transmission pipe 206 is made of a material characterized by acid resistance and alkali resistance, for instance.

The power supply 208 is coupled to the electromagnetic valve 204 for opening or closing the electromagnetic valve 204. Here, the power supply 208 is coupled to the electromagnetic valve 204 through a wire 408, for instance.

How the vacuum system 200 prevents fluids from back-streaming is exemplified hereinafter, while the invention is not limited thereto.

With reference to FIG. 3 to FIG. 5, when the pump 202 of the vacuum system 200 operates in a normal manner, the power supply 208 supplies electricity to the electromagnetic valve 204. At this time, the electromagnetic valve 204 is in the close state. That is to say, the gas transmission pipe 206 cannot supply the cylinder 124 of the piston device 104 with the gas coming from the gas source 600. The piston device 104 does not operate, and the fluid passage 118 in the case body 102 is in the open state, as indicated in FIG. 3. Hence, the gas in the manufacturing equipment 300 can be pumped and transmitted to the scrubber 500 by the pump 202.

When the pump 202 of the vacuum system 200 malfunctions or is shut down, the power supply 208 stops supplying the electromagnetic valve 204 with electricity, and the electromagnetic valve 204 herein is in the open state. In other words, the gas transmission pipe 206 can supply the cylinder 124 of the piston device 104 with the gas coming from the gas source 600. At this time, the piston 122 is driven by the gas coming from the gas source 600, and thereby the piston device 104 operates and pushes the blocking plate 106 to a relatively high position, such that the blocking plate 106 and the first case part 108 are tightly bonded to seal the first opening 112, and that the fluid passage 118 in the case body 102 is in the close state, as shown in FIG. 4. The back-streamed fluid caused by the malfunctioned or shut-down pump 202 is blocked by the blocking plate 106 and cannot pass through the check valve 100. Thus, pollutants including particles and powder in the gas can be prevented from back-streaming to the manufacturing equipment 300, and the manufacturing equipment 300 is not damaged or contaminated by the pollutants.

As described in the above-mentioned embodiments, the vacuum system 200 has the check valve 100, and the check valve 100 can block the back-streamed gas, so as to prevent pollutants including particles and powder in the gas from back-streaming to the manufacturing equipment 300. As such, the manufacturing equipment 300 is not damaged or contaminated by the pollutants.

To sum up, the invention as set forth in the above embodiments at least has the following advantages:

The check valve described in the above embodiments can effectively prevent the fluids from back-streaming.

Fluids can be rapidly isolated by the check valve described in the embodiments of the invention. Moreover, the manufacturing costs of the check valve are low, and the check valve can be easily installed.

The vacuum system described in the above embodiments can effectively prevent the gas from back-streaming, such that the manufacturing equipment is not contaminated.

Although the invention has been described with reference to the above embodiments, it will be apparent to one of the ordinary skill in the art that modifications to the described embodiments may be made without departing from the spirit of the invention. Accordingly, the scope of the invention will be defined by the attached claims rather than by the above detailed descriptions.

What is claimed is:

1. A check valve comprising:
a case body comprising:
a first case part having a first opening; and
a second case part having a second opening and a third opening, the second opening facing the first opening, the third opening being located at one side of the second opening, wherein the first case part and the second case part are combined to form the case body, and the case body has a fluid passage therein;
a piston device aligned to the second opening and mounted on the second case part; and
a blocking plate disposed on the piston device, wherein when the piston device operates, the piston device pushes the blocking plate to seal the first opening.

2. The check valve as claimed in claim 1, wherein the blocking plate has a ring-shaped protrusion, the first case part has a ring-shaped slot for accommodating the ring-shaped protrusion, and the ring-shaped slot surrounds the first opening.

3. The check valve as claimed in claim 2, further comprising an O-shaped ring disposed in the ring-shaped slot.

4. The check valve as claimed in claim 2, wherein a shape of a cross-section of the ring-shaped protrusion comprises a cone shape or a rectangular shape.

5. The check valve as claimed in claim 1, wherein the blocking plate has a retaining lever extending toward a direction of the first opening, the first case part has a retaining element extending into the first opening and having a hole, and the retaining lever passes through the hole.

6. The check valve as claimed in claim 1, further comprising a first combination device for combining the first case part and the second case part.

7. The check valve as claimed in claim 1, further comprising a second combination device for mounting the piston device on the second case part.

8. The check valve as claimed in claim 1, wherein the piston device comprises:
a piston; and
a cylinder for accommodating the piston.

9. The check valve as claimed in claim 8, wherein the cylinder has a vent hole thereon.

10. A vacuum system for performing a vacuum pumping process on manufacturing equipment, the vacuum system comprising:
a pump; and
the check valve as claimed in claim 1, the check valve communicating the pump and the manufacturing equipment.

11. The vacuum system as claimed in claim 10, further comprising an electromagnetic valve, the electromagnetic valve having a gas inlet and a gas outlet, the gas outlet communicating a vent hole of the piston device.

12. The vacuum system as claimed in claim 11, further comprising a gas transmission pipe communicating the gas inlet to a gas source.

13. The vacuum system as claimed in claim 11, further comprising a power supply coupled to the electromagnetic valve.
